(19) United States
(12) Patent Application Publication
(10) Pub. No.: US 2009/0018879 A1
(43) Pub. Date: Jan. 15, 2009

(54) METHOD AND SYSTEM SUPPORTING BUSINESS SOLUTION VALIDATION IN A COMPONENT BUSINESS MODEL

(76) Inventors: David Bernard Flaxer, Port Hadlock, WA (US); Robert H. Guttman, Stamford, CT (US); Jun-Jang Jeng, Armonk, NY (US); Juhnyoung Lee, Yorktown Heights, NY (US); Nitinchandra Nayak, Ossining, NY (US); Jin Min Xu, Beijing (CN)

Correspondence Address: Whitham, Curtis, Christofferson & Cook, P.C., Suite 340, 11491 Sunset Hills Road, Reston, VA, 20190, US

(21) Appl. No.: 11/777,606

(22) Filed: Jul. 13, 2007

(51) Int. Cl. G06F 9/44

(52) U.S. Cl. 705/7

(57) ABSTRACT

A method and system for validating business solutions by evaluating the business services from which the solution is composed, aggregating these evaluations in accordance with a service composition structure, and comparing the aggregated evaluation to target objectives for the business solution, where the service evaluations and the target objectives use the same metrics, which are surrogates for the business solution objectives. A business solution has a Business Level Agreement (BLA) which states business objectives. A business service has a Business Service Level Agreement (BSLA) which states operational objectives. A business solution is seen as a composition of business services. Therefore, the BLA is validated by evaluating and then aggregating the BSLA's for all business services from which the business solution is composed, and then comparing the aggregation against target values of the surrogates. Validation occurs: (1) during solution template composition, (2) at service binding times, and (3) during solution execution via business monitoring.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to validating business solutions that use a component business model.

2. Background Description

Business solutions need to conform to business strategy and objectives. This means that the design of business solutions must be flexible, and consequently business solution validation and optimization also needs to be flexible. Service oriented architectures (SOA) introduce the ability to create business solutions from compositions of business services. Validating that the business solutions composed of business services can meet business objectives is challenging. Business solutions need to be kept aligned with other aspects of the enterprise, such as resources, processes, people, and technology.

### SUMMARY OF THE INVENTION

It is therefore an object of the present invention to determine if a business solution is meeting or can meet its business objectives.

A business solution has a Business Level Agreement (BLA) which states business objectives. A business service has a Business Service Level Agreement (BSLA) which states operational objectives. A business solution is seen as a composition of business services. Therefore, the BLA is validated by evaluating the composition of BSLAs for all business services comprising the solution. This evaluation technique is applicable: (1) during solution template composition, (2) at service binding times, and (3) during solution execution via business monitoring.

In one aspect, the invention is a method for business solution validation in a component business model. One step in the method is defining a business solution composed of a set of services exposed by components in a component business model of a business, the services being formed into a service composition structure. Another step is evaluating each of the services according to metrics that are surrogates for metrics measuring objectives of the business solution. A further step is aggregating the service evaluations in accordance with the service composition structure. A final step is comparing the aggregation against target values of the surrogate metrics measuring the business solution objectives to validate the business solution.

In another aspect of the invention, the surrogate metrics for evaluating services are defined in a Business Service Level Agreement (BSLA) for each service composing the business solution. Furthermore, the surrogate metrics may be found by statistical analysis using data in a CBM repository to compare metrics defined in a Business Level Agreement (BLA) with metrics defined in said BSLAs.

In a further aspect of the invention, the comparing step occurs during solution template composition, at a binding time for said services, and during execution of said solution. Further, the comparing step may be used during solution template composition to select among alternative service choreographies for the solution. The comparing step may also be used to bind particular service providers to a selected service choreography for the solution. Another use of the comparing step is to monitor performance of the business solution.

Another aspect of the invention is where the aggregation reflects synergistic effects and/or cannibalizing effects among solution elements, the effects being represented in one or more linear or non-linear mathematical formulae or rules. In a further aspect of the invention the service composition structure may include one or more composition relationships between and among services: probabilistic invocation relationships, parallel invocation relationships, sequential activation relationships, as well as relationships in which a service is activated based on some algorithmic combination of predecessors, such as first-to-trigger or all-must-trigger.

The invention uses the Component Business Model (CBM) described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important to emphasize that the boundaries between managing concepts (and between components within managing concepts) are logical rather than physical.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a simplified representation of a Component Business Model metamodel.

FIG. 2A is a schematic diagram showing a business solution choreographed as a linear composition of services of CBM components.

FIG. 2B is a schematic diagram as in FIG. 2A showing a representation of a complex business solution choreographed as a non-linear composition of services of CBM components.

FIG. 3 is a schematic diagram showing an exemplar service composition from components displayed on a CBM map.

FIG. 4 is an extension of the metamodel shown in FIG. 1, showing Business Level Agreement validation from composition of evaluations of constituent Business Service Level Agreements.

FIGS. 5A and 5B show a conceptual representation, within the context a business integration graph, of the development (from FIG. 5A to FIG. 5B) of the invention's connection between BLAs and BSLAs.

FIG. 6 is a conceptual representation of the task of combining an evaluation of the BSLAs of constituent business services to validate the BLA of a business solution.

FIG. 7 shows a simple example of application of the invention.

FIGS. 8A, 8B and 8C, respectively, show application of the invention at the time of building a business solution template, the time of service provider selection, and the time of business performance evaluation.

FIG. 9 is a flow chart showing the relationship between the evaluations described in FIGS. 8A, 8B and 8C.

FIG. 10A is a diagram of a service composition structure including probabilistic invocation and sequential activation relationships between services; FIG. 10B is a diagram of a service composition structure including parallel invocation and fastest-predecessor-triggered activation relationships between services; FIG. 10C is a diagram of a service composition structure including parallel invocation and synchronized activation relationships between services.

FIG. 11 is a schematic diagram showing use of a component business model as a lens into business solution validation by business service composition.

FIG. 12 is a schematic diagram of the architecture for supporting business solution validation in a component business model by business service composition.

FIG. 13 is a mock up of a screen shot of an interface for a tool for supporting business solution validation in a component business model by business service composition.

### DETAILED DESCRIPTION OF A PREFERRED EMBODIMENT OF THE INVENTION

A business solution delivers a specified set of capabilities that supports a business objective. It includes the people, technology, processes, and other resources that enable the business to achieve its purpose. A business solution can have wide ranging capabilities. The perceived complexity that enables a capability is based on point of view of the observer, thus establishing the notion of relative granularity. For example, a solution may appear from the consumer's point of view as a simple transaction, but from the provider's viewpoint may be an intricate and lengthy interaction between many business services. A business solution may in fact be a single business service or an aggregation of services. The idea of relative granularity is based on the level of decomposition of business capabilities that is suitable for management of the particular business, with the management needs of a large enterprise generally requiring a greater level of decomposition than what is required for a smaller enterprise.

A business value can be applied to every business solution. And since a business solution is a composition of one or more business services the value of the business solution can be viewed as the composition of values of the business services that support it. The present invention takes this approach, and provides a methodology for validating and optimizing business solutions composed from services defined by the component business model (CBM) as described in the above referenced foundation patent application.

The decomposition of a business into discrete business components enables a business centric view of the enterprise and facilitates its management and transformation. CBM describes a basic organizing concept, a paradigm in which the business is seen as set of independent business components that collaborate to realize business solutions. A business component is a well bounded decomposition of an enterprise and houses an entire environment that constitutes a slice or segment of the business that includes all resources, infrastructure and facilities and that enable the business component to achieve its business purpose.

One of the advantages of business decomposition is that the organizing framework provided by CBM can facilitate a more effective understanding of business problems, requirements and evaluation, and enables better solution generation than other frameworks provide. For example, rather than seeing a business as independent threads of processes that weave through the “blob” of the enterprise, in a business decomposition the focus is on business components that are endowed with specific business capabilities and resources, and how they interact with other components to enable the purposes of the business. This world view is particularly effective for business analysts and strategic business planners who need to see and evaluate the business holistically using an organizational perspective, considering many factors, including resources consumed (costs) and benefits generated (value). CBM supports a wide range of analytic techniques and methods within its framework and does not restrict the type or character of business evaluation.

In CBM, business components interact with one another to meet the business goals. To accomplish this, business components offer their capabilities through the business services they expose. The granularity of a business service in a CBM description of the components of the business is set so that it is suitable to the purposes of the business and can support collaboration with other components. A business component can thus be viewed as a service center, a perspective that supports the strategically important notion of Service Oriented Architectures (SOA). The decomposition model is an idealized framework that expresses business strategies through components and, through extensions of the model, can be leveraged to realize these strategies. This realization includes the creation and modification of technology and processes, and the allocation of resources such as people and finance. In the case of IT (Information Technology), coupling of business strategy to IT realization can be achieved through the application of model driven transformation frameworks in which models of business requirement are successively mapped and transforming into models of IT implementation.

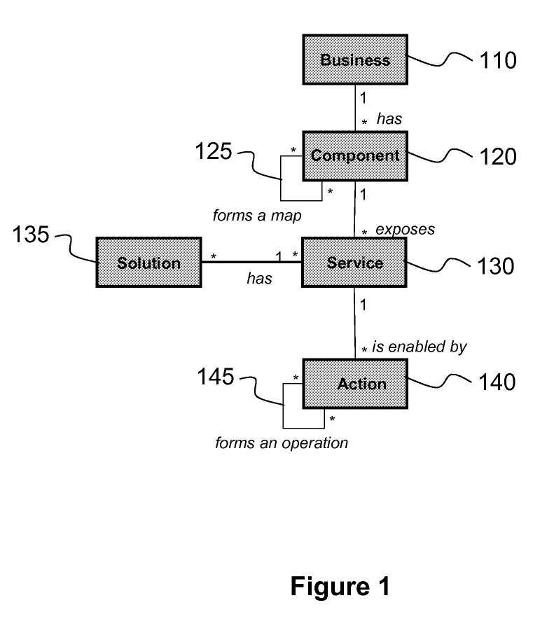

However, this coupling is in practice a difficult task. The present invention provides a methodology for extending by analogy the evaluation metrics commonly used for IT so as to provide suitable metrics for evaluating business objectives more broadly, as will now be explained with reference to FIGS. 1 through 13.

A simplified metamodel of the Component Business Model is illustrated in FIG. 1. A business 110 has a component 120 which exposes a service 130 which is enabled by an action 140. A component 120, along with other components, forms a map 125, and an exposed service 130, along with other services, forms a solution. An action 140, along with other actions, forms an operation 145.

FIG. 1 presents the following key elements and concepts:
Business 110: The logical representation of the complete and entire business.
Business Component 120: A partitioned unique chunk of the business responsible of all aspects of its business purpose.
Business Service 130: Business functions exposed by the component available to other components to consume
Business Action 140: Fined grained business functions encapsulated within the business component
CBM Map 125: The complete composition of the business from business components.
Solution 135: The complete composition of a business solution from business services.
Operation 145: The complete composition of a business service from business actions.

The Component Business Model reflects a level of granularity, as presented in Table 1, starting from the large grained level of the business element, with increasing fineness, through to business actions. This notion supports the concept of relative granularity, previously discussed, which facilitates an understanding between users with different points of view.

TABLE 1
Levels of Granularity

| Level | Element | Decomposition Level |
|---|---|---|
| 1 | Business | Complete Business |
| 2 | Component | Dedicated unit |
| 3 | Service | Available function |
| 4 | Action | Internal units of work |

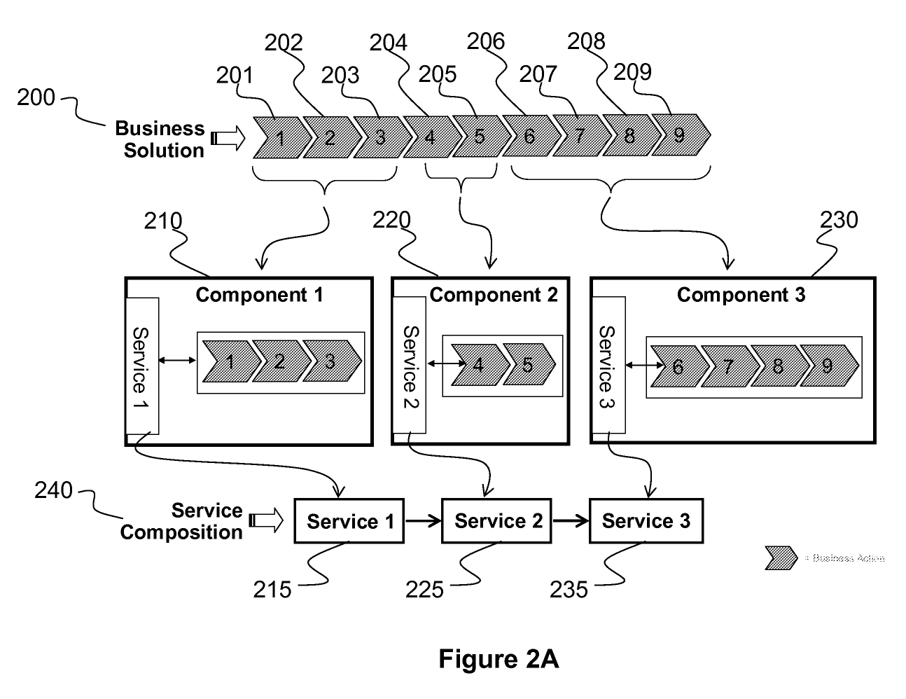

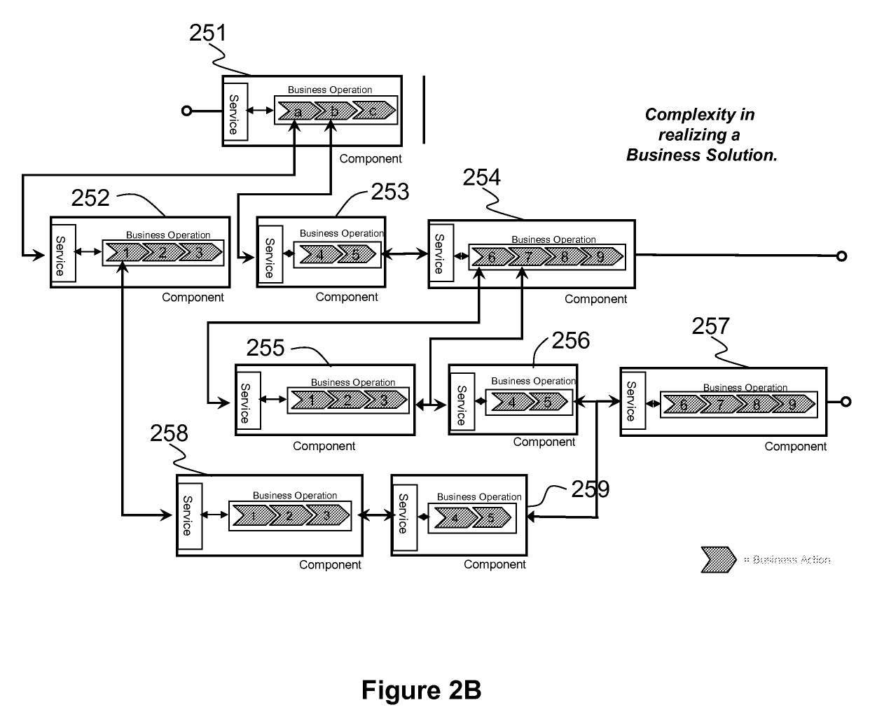

A business solution may be realized as a composition of business services that are choreographed to execute a sequence of finer grained business actions. In the Component Business Model business actions are encapsulated elements that support business services. FIG. 2A illustrates the concept of a business solution 200 supported by a sequence of actions (201 through 209), and its logical equivalent as a graph of business services 240, which is composed of Service 1 (215), Service 2 (225), and Service 3 (235). As illustrated, Service 1 (215) is provided by Component 1 (210) through business actions 1, 2 and 3 (201 through 203), Service 2 (225) is provided by Component 2 (220) through business actions 4 and 5 (204 and 205), and Service 3 (235) is provided by Component 3 (230) through business actions 6, 7, 8 and 9 (206 through 209).

It will be observed that because each component is a substantially self-contained locus for the resources required to perform its services, the component decomposition represented by a CBM map is suited to managing each component so as to optimize performance of its services, including outsourcing. Thus, composing a business solution of business services provides a flexibility that allows both the solution provider and consumer to employ the most effective service provider to meet business goals. Such concepts are represented in service architectures, dynamic or virtual enterprises and outsource solutions.

Providers and consumers can be thought of as general contractors, assembling and managing the whole enterprise from a set of parts, where each part is a business service associated with a business component. The Component Business Model represents a logical framework for the organization of a business, independent of how that logical framework is realized. In the extreme, the entire entity can be realized as a virtual business comprised of outsourced business services that are selected, choreographed and bound to form a business solution.

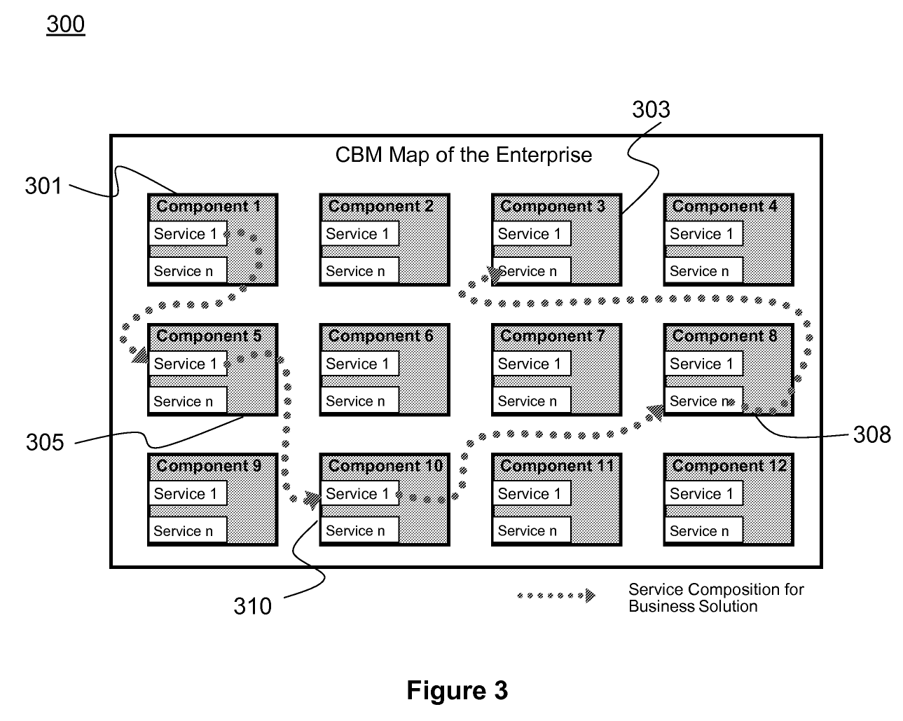

A business solution is thus represented as a directed graph of business service interactions within a logical business topology. This is illustrated in FIG. 3, in which the dotted line represents a simple choreograph of business services for a business solution. In the business solution illustrated, Service 1 provided by Component 1 (301) serves as an input to Service 1 of Component 5 (305), and this sequence continues through Service 1 of Component 10 (310), Service n of Component 8 (308), and Service n of Component 3 (303).

While the choreography of services shown in FIGS. 2A and 3 are simple linear flows, in general service compositions may reflect complex business flows. For example, compare the flow shown in FIG. 2A with the more complex solution shown in FIG. 2B, which is composed from services provided by components 251 through 259, triggered by an input to the service provided by component 251. Observe that the solution is not composed from service to service along a sequential chain. For example, inputs to components 252 and 253 are provided from component 251, but not from the service output provided by component 251, which is not used. Instead, these inputs are provided by business actions “a” and “b”, respectively, from the business operation performed by component 251. This may be viewed as a fork from component 251 to components 252 and 253. Similarly, business actions “6” and “7” in the business operation performed by component 254 provide service inputs to components 255 and 256, respectively. Business action 1 in the business operation performed by component 252 provides an input to the service provided by component 258. Service outputs from components 253 and 258 provide inputs for the services provided by components 254 and 259, respectively. The service outputs from both components 256 and 259 are joined as input to the service provided by component 257. Similarly, there is a join at the service input to component 256, formed by the service output of component 255 and business action “7” from the business operation performed by component 254. In the end, the solution is comprised of the service outputs of components 254 and 257.

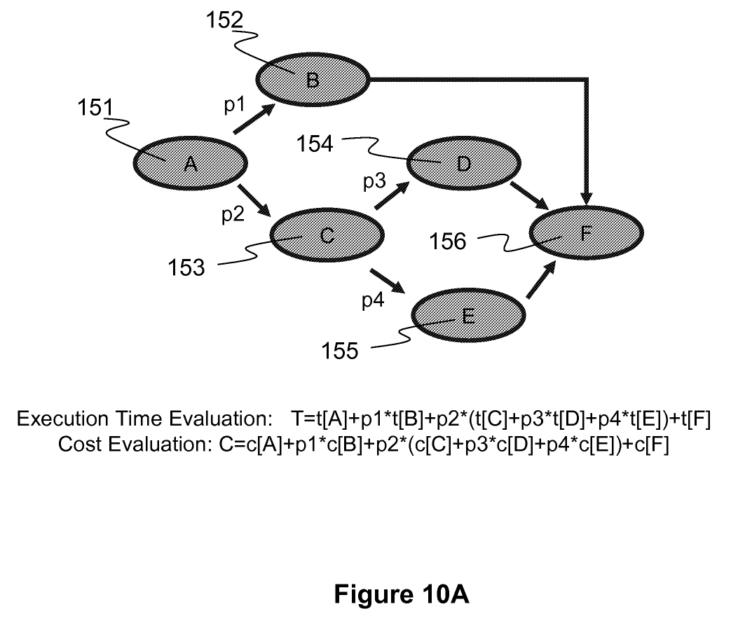

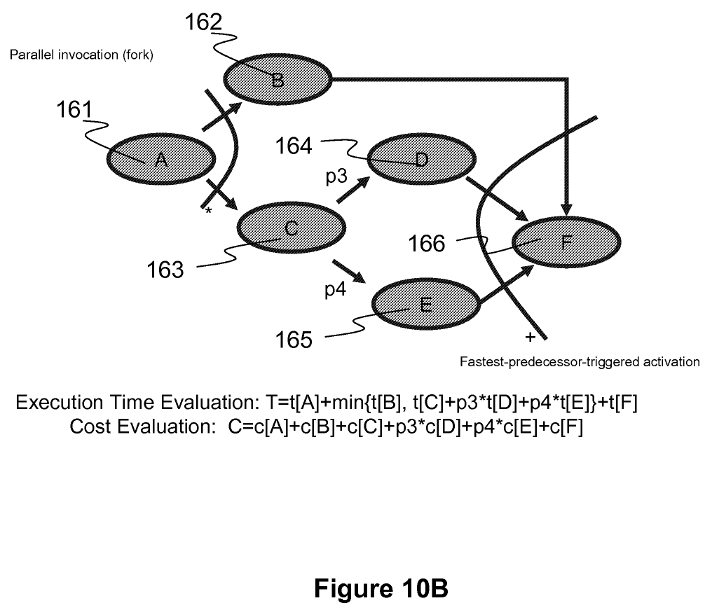

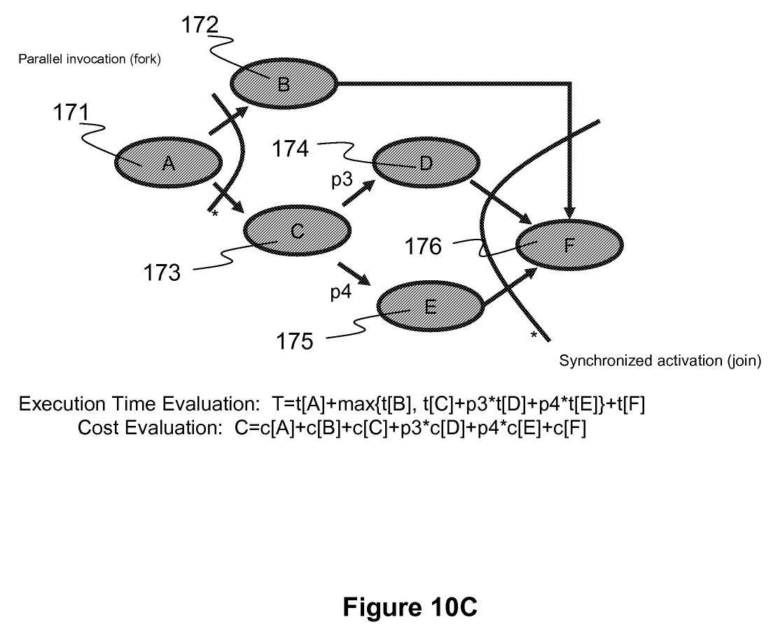

These more complex solutions shown in FIG. 2B can include the application of composition logic constructs such as forks, joins and loops, which enable the specification of control logic, concurrency and repetition, as will be described in more detail in connection with FIGS. 10A, 10B and 10C. Service compositions can be represented by service specification languages such as Business Process Execution Language (BPEL). Throughout the remainder of this invention disclosure the concept of the virtual business will apply, meaning business services (i.e. the components that provide these services) may exist within an enterprise or may be outsourced to external entities.

The invention establishes the general notation of “Business Level Agreement Composition” and extends the CBM capability, as described in the above referenced foundation patent application, to evaluate business solutions as collaborations of services provided by business components, adding BLA (Business Level Agreement) and BSLA (Business Service Level Agreement) as new elements in the CBM framework established by the above referenced foundation patent application. The invention provides a methodology for constructing a valuation of a BLA from a composition of evaluations of BSLAs of the constituent services that perform the solution to be measured by the BLA.

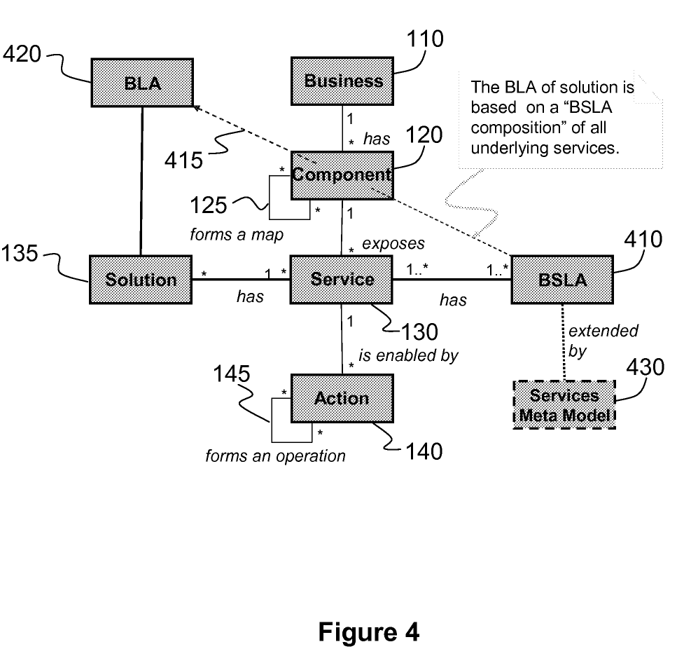

The metamodel extension of CBM established by the invention is shown in FIG. 4, which expands on the basic metamodel shown in FIG. 1. There is a BSLA 410 for every service 130 comprising solution 135. Optionally, BSLA 410 can be extended by a service metamodel 430. Solution 135 satisfies certain objectives, associated with the business 110, and the criteria for evaluating the adequacy of solution 135 are reflected in BLA 420. As is customary for a robust implementation of CBM, the metrics and benchmarks of each BSLA are associated with the respective component 120 that exposes the respective service 130, the respective component 120 being included in a mapping 125. This mapping provides access to the full range of CBM repository data, as well as access to the full range of CBM relationships which connect components to other CBM elements. Using the accessible CBM data and CBM relationships, the BSLAs 410 of the constituent services 130 making up the business solution 135 may be composed so as to measure performance against the BLA 420. This use of CBM data and relationships associated with the mapping 125 of components 120 to compose a BLA 420 measure in this fashion is indicated by the dashed line 415 running from BSLA 410 through component 120 to BLA 420.

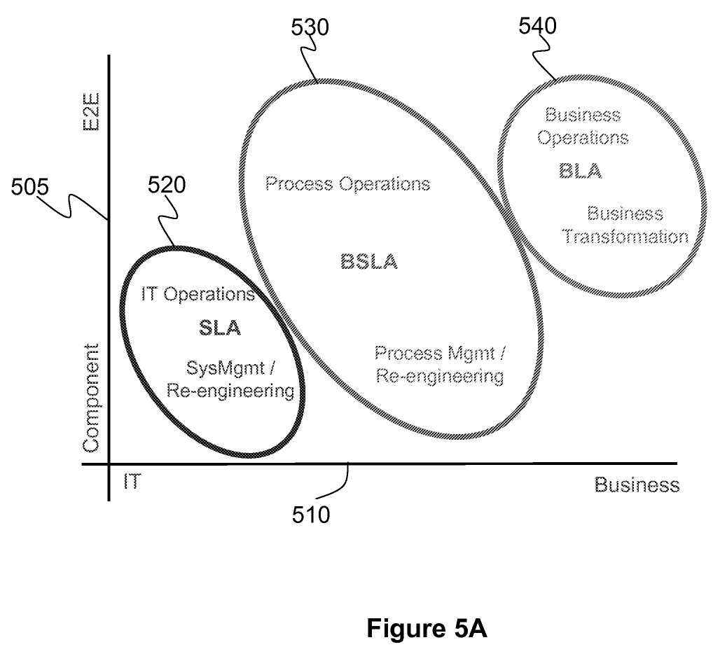

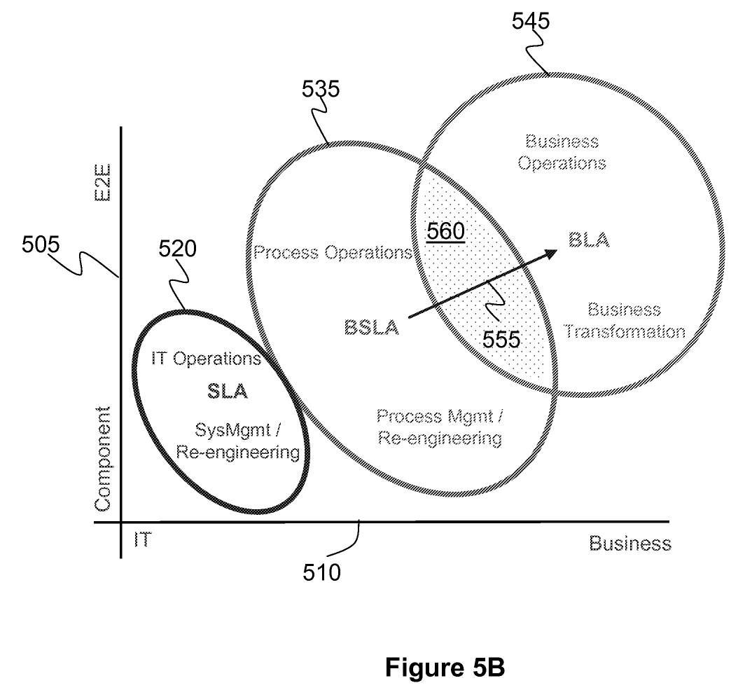

Turning now to FIGS. 5A and 5B, the composition methodology of the invention and the problems presented by the prior art will be further explained. It will be noted that the Service Level Agreement (SLA) 505 is commonly used in the provision of IT services. The SLA specifies performance parameters by which the delivery of IT services is to be measured. For example, the SLA might specify that a server for the customer will be available 99.9% of the time, among other measures. These measures pertain to IT operations and evaluation of performance according to these measures informs and enables management and re-engineering of IT systems. By extension of this concept, a BSLA 530 would specify performance criteria for a service exposed by a component of the business, and a BLA 540 would specify performance criteria for a solution provided by the business.

As shown in FIG. 5A, differences between an SLA, a BSLA and a BLA may be expressed in terms of at least two axes. An SLA is concerned with IT operations whereas a BLA is concerned with the operation of the business, and a BSLA is concerned with the operation of processes used to operate the business. IT operations tend to support components, whereas business operations provide support to enterprises outside the business, and process operations generally fall between these. This progression from a component level focus to an enterprise-to-enterprise (E2E) focus is shown by axis 505. Similarly, there is a progression from a focus upon the management and re-engineering of IT systems to a focus upon transformation of the business within (and responsive to) the larger marketplace within which the business operates. Attention to management and re-engineering of processes of the business fall between these. Axis 510 provides a representation of this progression.

It will be observed that performance measures for IT operations are well understood and are often monitored automatically. These measures (e.g. percentage up-time, CPU availability) are low level measures specific to IT operations and the IT infrastructure serving the business. It is straightforward to add IT infrastructure resources in order to meet performance measures in an SLA. At the other end of the axis 510, business operations are at a higher level of abstraction and it is more difficult to know what to change in order to improve the conventional measures for achieving business objectives (e.g. revenue generation, profit margin, etc.). These conventional “bottom line” measures do not provide or suggest an analysis of how a business can make its operations more valuable to its customers or how these operations can be transformed to improve performance of the business in the marketplace. Thus it is not obvious how the well known SLA model can be applied in a practical way to performance agreements at the level of business objectives.

The approach that the present invention takes to this problem is to build upon the services (i.e. item 130 in FIG. 4) which compose the solution (i.e. item 135 in FIG. 4) that is the subject of a BLA (i.e. item 420 in FIG. 4; item 540 in FIG. 5A). These services may have their own business service level agreements (i.e. BSLA: item 410 in FIG. 4; item 530 in FIG. 5A). The premise of the invention is that it is feasible to develop performance measures for a BSLA 410 such that a business solution 135 composed of services 130 can be provided performance measures that are a composition based on the BSLAs 410 of the services 130 making up the solution 135.

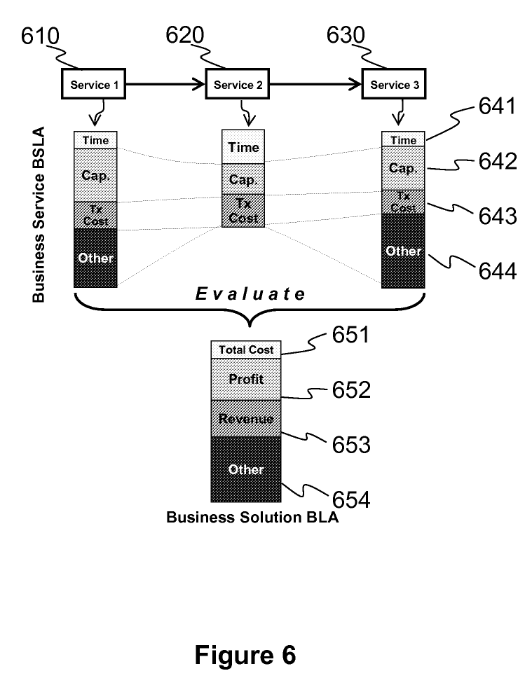

This approach to making BLAs feasible is shown schematically in FIG. 5B. The use of BSLAs to generate performance measures for a BLA is represented by the arrow 555 and the overlap area 560 between BSLA 535 and BLA 545. A schematic implementing this approach for a simple linear combination of service 1 (item 610), service 2 (item 620) and service 3 (item 630) is shown in FIG. 6. In the example, the performance of each service is broken down into time 641, capacity 642, transaction cost 643, and other 644. These performance measures are reflected in a BSLA for each of the services (i.e. items 610, 620 and 630). Evaluations of each composite service against its corresponding BSLA will result in a composite evaluation that will be used as a surrogate for an otherwise difficult direct evaluation of the measures of the BLA, e.g. the contribution of the solution 135 to the total cost 651, profit 652, revenue 653, and other 654.

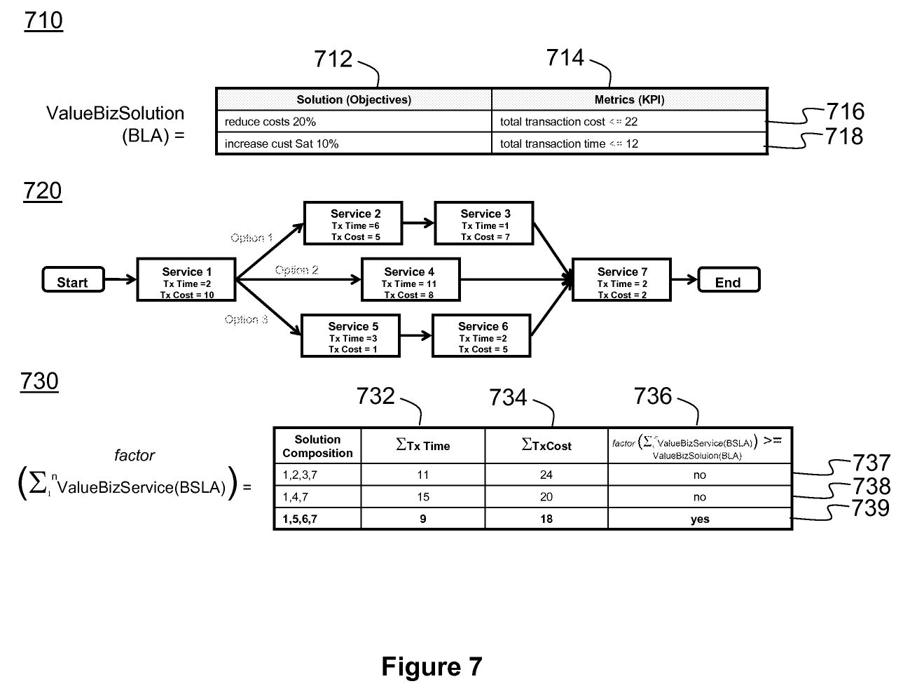

A simple example of how this works is shown in FIG. 7. At the top of FIG. 7 is a table 710 showing the business objectives 712 of the solution and corresponding metrics 714 that will serve as an evaluative measure for the business solution. One example of a business objective 716 is a 20% cost reduction, and this objective will be satisfied if total transaction cost for the business solution is less than or equal to a value of 22 (for a suitably normalized metric). A second objective 718 is to increase customer satisfaction by 10%, which will be satisfied if total transaction time for the business solution is less than or equal to 12 (again, for a suitably normalized metric). Together, these two criteria provide a basis for a simple “yes” or “no” answer to the question whether the value of the solution meets the business objectives of the solution. Note that transaction time and cost are used as surrogates in the examples that follow, but that the invention can also be applied to other measures or combinations of measures that are found (by experience and analysis) to serve as suitable surrogates.

In the middle of FIG. 7 is a flow chart 720 showing several options for composing services to reach a solution meeting the stated business objectives. For each service in the composition, the results of the corresponding BSLA evaluation are presented in the form of a transaction time and a transaction cost. These times and costs are summarized in the following table:

TABLE 2
BSLA Component Evaluations

| Component | | |
|---|---|---|
| Service | Transaction Time | Transaction Cost |
| 1 | 2 | 10 |
| 2 | 6 | 5 |
| 3 | 1 | 7 |
| 4 | 11 | 8 |
| 5 | 3 | 1 |
| 6 | 2 | 5 |
| 7 | 2 | 2 |

The composite results for each of the three solution options are shown in the table 730 at the bottom of FIG. 7. The solution 737 composed of services 1, 2, 3 and 7 shows a total transaction time (in column 732) of 11 (which meets the time objective because it is less than 12) and a total transaction cost (in column 734) of 24 (which is over 22 and therefore fails to meet the cost objective). Thus Option 1 fails to meet both objectives, as indicated by a “no” in the evaluation column 736. The second option 738 (composed of services 1, 4 and 7) also fails, but for the opposite reason. The total transaction cost is less than 22 and therefore meets the cost objective, but the total transaction time is more than 12 and therefore fails.

Only the last option 739, Option 3 composed of services 1, 5, 6 and 7, meets both criteria. This option has a total transaction time of 9 (which is less than 12) and a total transaction cost of 18 (which is less than 22). Since both criteria are met the solution is valid, as indicated by a “yes” in the evaluation column 736.

The flow chart 720 can be modified to illustrate some additional effects that may complicate this simple example. For example, there may be certain synergies if two services are provided by the same vendor, enabling a discount for bundling the two services. Under this discount scenario for Option 1, the transaction cost for Service 3 is reduced from 7 to 5, reducing the total transaction cost to 22 and thereby allowing this option to meet both objectives and receive a “yes” evaluation. Another example of a complicating effect would be a configuration surcharge where the same vendor performs two services, e.g. services 5 and 6. In such an instance of cannibalization, the transaction cost of service 5 increases from 1 to 6, thereby raising the total transaction cost to 23, which removes Option 3 from validation. These complicating effects, whether synergistic or cannibalizing, may be expressed in linear or non-linear mathematical formulae or rules.

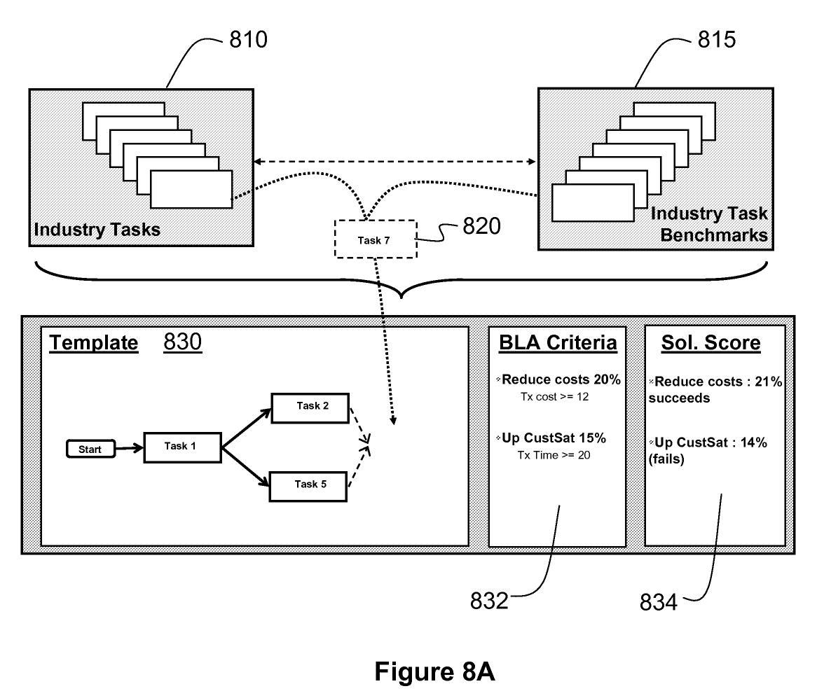

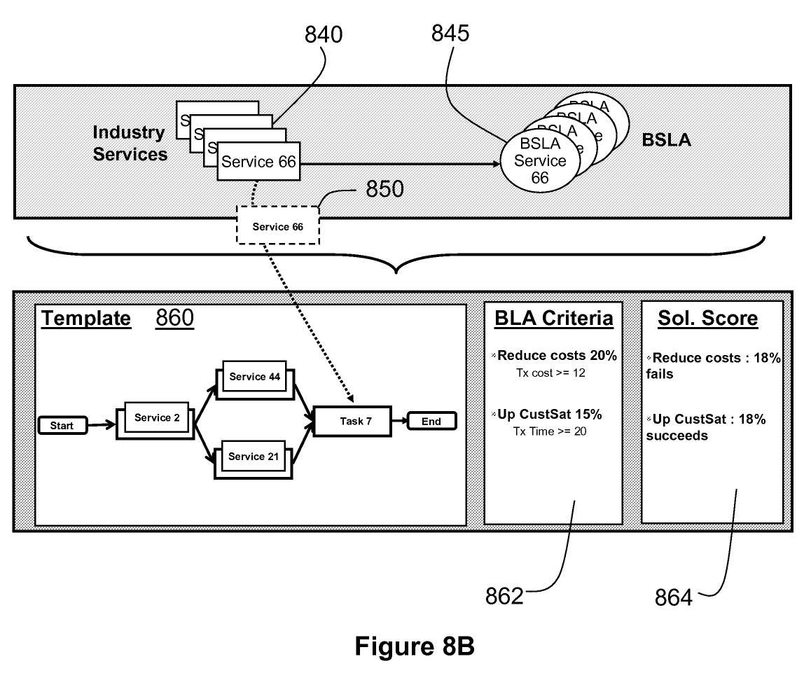

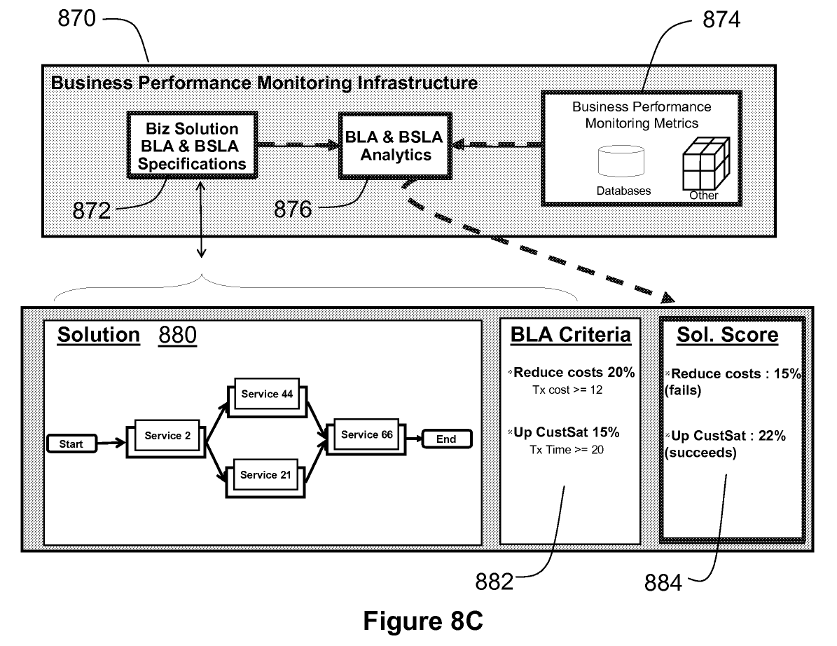

Turning now to FIGS. 8A, 8B, and 8C there is shown application of the invention at the time of building a business solution template (FIG. 8A), the time of service provider selection (FIG. 8B), and the time of business performance evaluation (FIG. 8C). At the time of building a business solution, shown in FIG. 8A, we see a partially complete template 830 with Task1 followed in parallel by Task 2 and Task 6. From a dictionary 810 of industry tasks, evaluated by industry task benchmarks 815, a further Task 7 (item 820) is selected for addition to the solution in serial order following Task2 and Task 6. Using the industry task benchmarks 815, the composite solution score 834 for the solution at this template building stage, when evaluated against the BLA criteria 832, shows that this solution passes the cost reduction measure (21% against a target of 20%) but fails to increase customer satisfaction by the desired amount (14% against a target of 15%).

This stage of evaluation is based on tasks using industry benchmarks. Alternative solutions (not shown) could be explored using an industry task dictionary and corresponding benchmarks. Recall that such alternatives are shown in template 720 of FIG. 7. However, for the purposes of understanding the present invention let us address the next evaluation stage for the solution built as shown in FIG. 8A. In this next stage, shown in FIG. 8B, actual service providers are selected for the component tasks defined in the solution template 860. For example, industry service providers 840 each subscribe to a BSLA 845. Let us suppose that service provider 850 is selected for performance of Task 7, thus completing the provider selection for solution template 860. The solution may again be evaluated, based on the BSLAs negotiated with the selected service providers, as measured against the same BLA criteria 862. Under this evaluation, the solution score 864 shows an increase in customer satisfaction of 18%, exceeding the target of 15%, but a cost reduction of only 18% fails to meet the target of 20%. This result is the reverse of the evaluation at the template building stage.

Again, as at the template building stage, a number of alternative service provider combinations may be evaluated according to the respective BSLAs of the service providers being considered. But after a business solution has been implemented by selection of a solution template 880 and selection of service providers for the tasks identified in the solution template 880, the invention provides a third stage of evaluation, as shown in FIG. 8C. The business solution 880 is defined by specifications 872 reflected in the BLA criteria 882 applicable to the solution and the BSLA applicable to each of the selected service providers of the components that make up the solution. During execution of the solution, business performance is monitored by a metrics 874 which feeds an analysis 876 based on the BLA and the BSLA, producing a solution score 884. The business solution specifications 872, the performance monitoring metrics 874 and the analytics 876 in combination provide a business performance monitoring infrastructure 870 that supports this third stage of evaluation according to the invention. As shown in FIG. 8C, the solution score 884 based on actual performance meets the customer satisfaction target but falls short of the cost reduction target. As will be understood by those skilled in the art, performance monitoring infrastructure 870 may be adjusted and used during performance to provide feedback to solution managers and service providers with a view toward optimizing performance. Within the constraints provided by the contractual agreements supporting the BLA and the BSLAs, performance monitoring evaluations may prompt further evaluation and possibly changes in the solution template applied and the service providers selected.

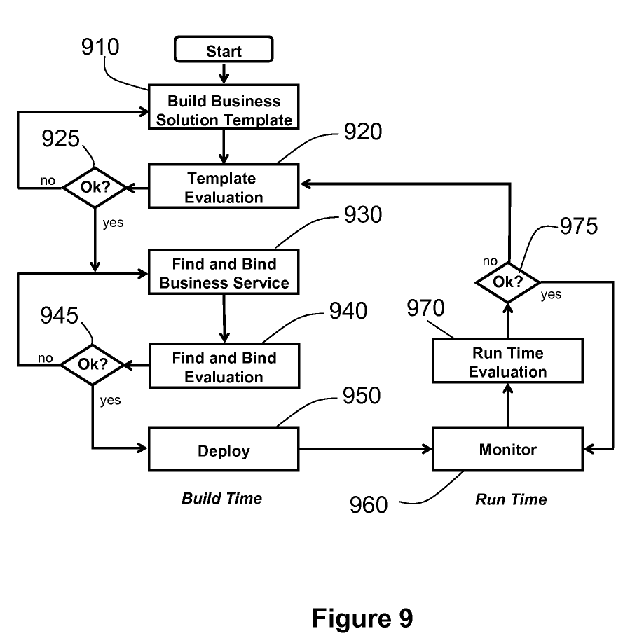

The operation of the evaluative technique of the invention during all three stages described in FIGS. 8A, 8B and 8C may be summarized in the flow chart shown in FIG. 9. In the first stage 910 a business solution template is built and then evaluated 920 in accordance with the invention. If the results 925 of the evaluation 920 are satisfactory, then providers of appropriate services are located 930. If the results 925 of the evaluation 920 are not satisfactory then the solution template is rebuilt 910 and reevaluated 920 until acceptable results are obtained.

When suitable service providers are found and corresponding BSLAs permit binding the providers to the solution template, a second stage evaluation 940 is performed in accordance with the techniques of the invention. As with the first stage evaluation, if the results 945 are not satisfactory, the step of finding suitable service providers and corresponding BSLAs 930 is repeated until the results 945 of the evaluation 940 are acceptable, at which point the solution can be deployed 950. Upon deployment the performance of the solution is monitored 960 and the invention then provides a run time evaluation 970. So long as the results 975 of this third stage evaluation are satisfactory, monitoring 960 and evaluation 970 continue. If the results 975 of the performance evaluation 970 at run time are not satisfactory, then the suitability of the solution template is again evaluated 920, with template rebuilding 910 and service provider binding 930 as necessary until a revised solution is ready for deployment 950, thereupon replacing the earlier solution.

The invention describes a new middleware service responsible for capturing BLA and BLSA metrics from a plurality of sources and mapping them into a CBM model. Over time, a repository of such mappings accumulates and provides a rich source of data that can be analyzed to provide improved surrogate metrics at the BSLA level for corresponding BLA metrics. This middleware service provides an interactive tool to support the evaluation and optimization of business at: (1) service composition time, (2) binding time, and (3) solution run time. And the invention uses multiple business templates, by industry, based on best practices, to suggest strategies and recommendations for BLA and BLSA.

A business solution has the following attributes. It meets strategic objectives of the business. It is a stated deliverable of the business, at an appropriate level of granularity. It is achieved by the interaction of one or more business components through a choreography of Business Services. And it is realized by a Business Process consisting of a graph of Business Actions.

The defining validation relationship is:

$$factor ( {\sum }_{1}^{n} ValueBizService ( BSLA ) ) \geq ValueBizSolution ( BLA )$$

In other words, the “value” of the business service composition must meet or exceed the “value” of the business objectives for the solution.

A business solution is a composition of services. Each business service in the composition has a BSLA. The BLA for the business solution is evaluated against a composition of BSLAs for services. There are a variety of approaches available for evaluating the relationship between BLAs and BSLAs. Analytical techniques include queuing theory models for estimating time-based variables, and extensions to queuing theory models to estimate costs. Activity-based costing techniques can be used to estimate costs in providing business solution based on individual service-level costs. Discrete event simulation models provide models of a variety of time, cost, quantity-related metrics for each service involved and computing BLAs through simulation of business solution operation.

An example of approaches to evaluating the relationship between BLAs and BSLAs is the Composition Evaluation Technique (CET). In this technique BLA and BSLA can be expressed as a set of assertions on Key Performance Indicators (KPIs) or operational metrics. For example, a set of such assertions might be: i) revenue increases $300M; ii) average order processing cost is less than $6 per order; and iii) average order turn-around time is less than 3 days. Then, there are two fundamental operational metrics: a) execution time, t, per request; b) cost, c, per request. Finally, the technique examines the complete composition and the probability of possible paths through each service to determine if the composition can meet the BLA of the business solution. A probability can be input by a subject matter expert (SME) or through historical statistical data examination. Most (but not all) KPIs or operational metrics can be computed from these probabilities.

Formulating a BLA evaluation is done using the following scheme:

a) Inputs include

1) a set of available business services S;

2) a set of available business resources R;

3) a template T(V, E) which is a directed graph;

Each node v in V represents a business service with designated type, each directed link from s1 to s2 represents a potential invocation link. The actual invocation depends on the data condition at execution time.

4) a set of utility functions U, where each u in U maps a service and associated resources to a key performance indicator e.g. cost or time;

5) another set of utility functions U2, where each u2 in U2 maps key performance indicators to an overall key performance indicator at a process level;

6) an objective O as business level agreement.

b) Outputs include

1) a mapping from R to S;

2) quantified measurements manifested as key performance indicators that are associated with the realized template T;

c) Constraint: the objective O is evaluated to be true.

A Business Solution bs is composed of a set of services (s1, s2, . . . sn). For the corresponding BLA, a KPI k can be computed using:

k=F_{bs}(t, c)
t: process execution time per request
c: operational cost per request

For the set of services the BSLA s[i] (i=1,2 . . . n), KPI k[i] can be computed:

k[i]=F_{s[i]}(t[i], c[i])
t[i]: execution time per request for service s[i]
c[i]: cost per request for service s[i]

Let's seek the relationship between t and t[i] as well as c and c[i].

There are five composition relationships between services within a business solution template: 1) probabilistic invocation; 2) parallel invocation (fork); 3) sequential activation; 4) fastest-predecessor-triggered activation; and 5) synchronized activation (join).

FIG. 10A diagrams an example of a probabilistic invocation of services <A,B,C,D,E,F> related as shown in the diagram. Service <A> 151 is followed by services <B 152,F 156> with a probability p1, and is followed by service <C> 153 with a probability p2. Similarly, service <C> 153 is followed by services <D 154,F 156> with a probability p3, and is followed by services <E 155,F 156> with a probability p4. If each of the services <A,B,C,D,E,F> has a time (t) and a cost (c) associated with it, then the total time (T) and cost (C), respectively, for the solution <A,B,C,D,E,F> will be

T=t[A]+p1*t[B]+p2*(t[C]+p3*t[D]+p4*t[E])+t[F]

C=c[A]+p1*c[B]+p2*(c[C]+p3*c[D]+p4*c[E])+c[F]

FIG. 10B illustrates both a parallel invocation (a fork from service <A> 161 to both service <B> 162 and service <C> 163) and a fastest-predecessor-triggered activation (service <F> 166 is triggered by whichever option services <A 161,B 162> or services (<A 161,C 163,D 164> or <A 161,C 163,E 165>) completes first. In this scenario, the total time and cost, respectively, for the solution <A,B,C,D,E,F> will be

T=t[A]+min{t[B],t[C]+p3*t[D]+p4*t[E]}+t[F]

C=c[A]+c[B]+c[C]+p3*c[D]+p4*c[E]+c[F]

Similarly, FIG. 10C illustrates both a parallel invocation (a fork as with FIG. 10B) and a synchronized activation (service <F> is triggered when both options <A 171,B 172> and (<A 171,C 173,D 174> or <A 171,C 173,E 175>) have completed. In this scenario, the total time and cost, respectively, for the solution <A,B,C,D,E,F> will be

T=t[A]+max{t[B],t[C]+p3*t[D]+p4*t[E]}+t[F]

C=c[A]+c[B]+c[C]+p3*c[D]+p4*c[E]+c[F]

In all these scenarios, the metric for the BLA solution is built up from service level metrics provided by the business services that compose the solution. The service level metrics are the subject of respective BSLAs.

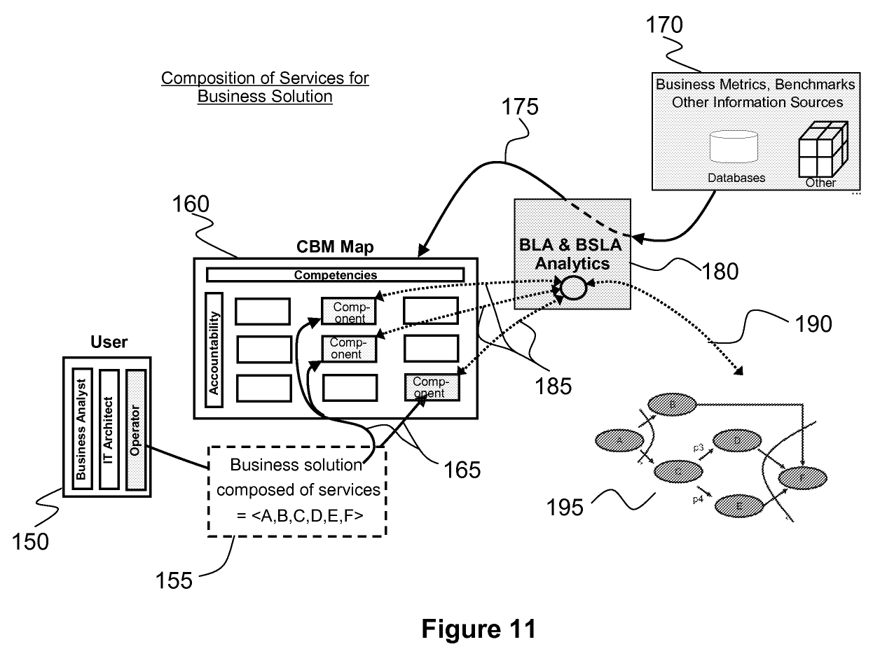

The present invention is based on the notion that CBM can be extended to be used as a framework in which to organize a business solution composed of services, as shown in FIG. 11. A user 150 of the invention may be a business analyst or IT architect, for example, or a wide range of other roles in the business. The invention presents the business solution 155 to the user 150 through the lens of a CBM map 160. For example, a business solution 155 may be composed of constituent services <A,B,C,D,E,F> as described above in connection with FIGS. 10A, 10B and 10C. The business solution 155 will be highlighted on the CBM map 160 in terms of the components 165 which provide the corresponding services.

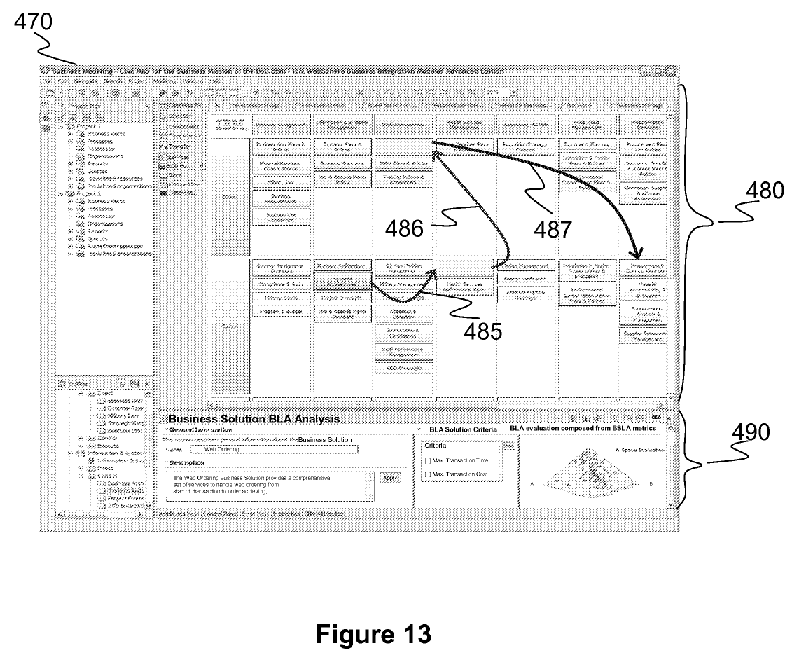

As described in further detail in the above referenced foundation patent application, the CBM map 160 serves as a repository for business information organized by component or other structure in the CBM metamodel. This information can be reached from a display of CBM map 160 by drill-down techniques well known in the art, including use of graphic overlays and companion windows, as demonstrated below in connection with FIG. 13. In order to adapt the CBM model to business solution validation, it is first necessary to incorporate into the CBM map 160 the information 170 of particular relevance to business solution validation. This information 170 will include business metrics, benchmarks, and other related business information useful in evaluating the business services which compose the solution. The evaluation is keyed to parameters determined by the BLA, as described earlier with respect to FIGS. 7, 8A, 8B and 8C. In preparation for this evaluation the information 170 is mapped 175 to CBM components and other CBM structures defined in the CBM metamodel (e.g. competencies and accountability levels), using the CBM map 160 as the organizing reference.

The information 170, which has now been added to the CBM map 160, supports an evaluation of the business solution against its BLA, where the evaluation of each BLA metric is based upon an evaluation of that metric for each of the services (e.g. <A,B,C,D,E,F>) from which the business solution is composed. The evaluation is controlled by an analysis function 180 reflected in the BLA and the BSLAs of the services. The composition of services follows a structure 195 (as described earlier in connection with FIGS. 10A, 10B and 10C). The BLA and BSLA controlled analytics 180 combines 185 the business information from CBM map 160 into service composition structure 195 in order to generate an evaluation of the business solution. The evaluation generated from application 190 of service composition structure 195 is then stored by the validation controller 180 to the business solution structure within CBM map 160

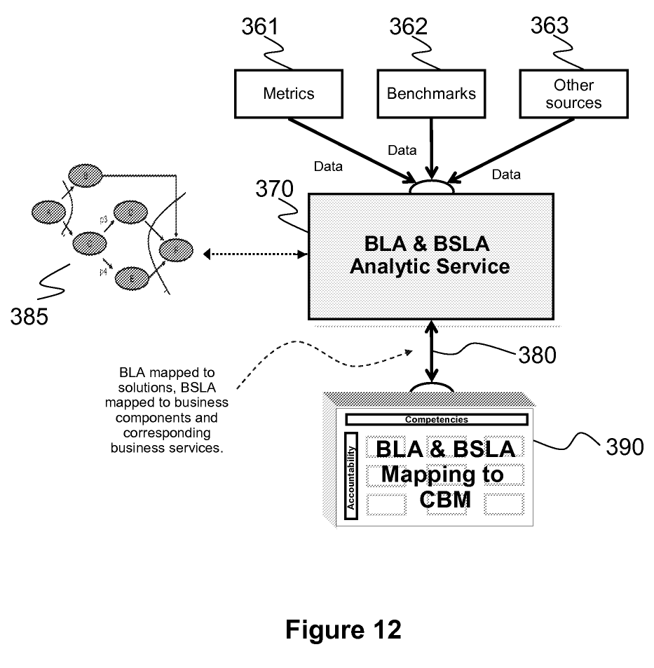

FIG. 12 presents a system level architecture that supports a preferred embodiment of the invention. The system architecture consists of four key elements:
1. Applications, services and databases provide business metrics 361, benchmarks 362 and other related business information 363.
2. A BLA & BSLA analytic service 370, introduced in the exemplar of this invention shown in FIG. 11, controls the mapping 380 of data (361, 362 and 363) to CBM components and other CBM structures 390 that are defined within the CBM metamodel, and also controls the process of evaluation of the respective services, as well as the composite evaluation of the business solution. The solution validation parameters are provided by the BLA and BSLAs.
3. A service composition structure 385 defines how the evaluations of the individual services according to their respective BSLAs are combined to produce a composite metric serving as a surrogate for each of the BLA metrics to be evaluated as part of the validation of the business solution.
4. The CBM structures 390 serve a repository for the underlying data (361, 362, 363) and also the computed evaluation metrics. User access to this information is enabled by representations upon the CBM map encoded by color, pattern or contained in object attributes. By selecting visual elements of the CBM map, the user can “drill-down” to obtain detailed information about validation of the business solution, as this validation progresses through the build time and run time evaluation phases described in FIG. 9.

FIG. 13 presents an illustration of a CBM Business Solution Validation Interface 970 for implementing the invention. The illustration highlights three key features:
1. The CBM map 480 of the enterprise consists of an ordered presentation of business components.
2. A business solution is composed from services provided by the components connected by lines 485, 486 and 487. The solution is shown as an interactive graph of business components that provide the function though the business services they expose.
3. A business solution validation “analysis center” 490 that displays such information as (a) information on the business solution, such as the title “Web Ordering” and a description (e.g. “the Web Ordering business solution provides a comprehensive set of services to handle web ordering from start of transaction to order archiving”); (b) a user selectable set of “business criteria” for specifying the target validation metrics; and (c) results of validation analysis presented in a graphic form.

Those skilled in the art will appreciate that the area occupied on interface 470 by “analysis center” 490 may also be used to set up the analysis using tools that interact with CBM map 480 to display and highlight the information mapped to the CBM database and other information available in the CBM database.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for business solution validation in a component business model, comprising:
defining a business solution composed of a set of services exposed by components in a component business model of a business, said services being formed into a service composition structure;
evaluating each of said services according to metrics that are surrogates for metrics measuring objectives of said business solution;
aggregating said service evaluations in accordance with said service composition structure; and
comparing said aggregation against target values of said surrogate metrics measuring said business solution objectives to validate the business solution.

2. A method as in claim 1, wherein said comparing occurs during solution template composition, at a binding time for said services, and during execution of said solution.

3. A method as in claim 1, wherein said comparing is used during solution template composition to select among alternative service choreographies for the solution.

4. A method as in claim 1, wherein said comparing is used to bind particular service providers to a selected service choreography for the solution.

5. A method as in claim 1, wherein said comparing is used to monitor performance of the business solution.

6. A method as in claim 1, wherein the aggregation reflects synergistic effects among solution elements, said effects being represented in one or more linear or non-linear mathematical formulae or rules.

7. A method as in claim 1, wherein the aggregation reflects cannibalizing effects among solution elements, said effects being represented in one or more linear or non-linear mathematical formulae or rules.

8. A method as in claim 1, wherein the service composition structure includes at least one probabilistic invocation relationship between services.

9. A method as in claim 1, wherein the service composition structure includes at least one parallel invocation relationship between services.

10. A method as in claim 1, wherein the service composition structure includes at least one sequential activation relationship between services.

11. A system for business solution validation in a component business model, comprising:
means for defining a business solution composed of a set of services exposed by components in a component business model of a business, said services being formed into a service composition structure;
means for evaluating each of said services according to metrics that are surrogates for metrics measuring objectives of said business solution;
means for aggregating said service evaluations in accordance with said service composition structure; and
means for comparing said aggregation against target values of said surrogate metrics measuring said business solution objectives to validate the business solution.

12. A system as in claim 11, wherein said means for comparing is executed during solution template composition, at a binding time for said services, and during execution of said solution.

13. A system as in claim 11, wherein said means for comparing is used during solution template composition to select among alternative service choreographies for the solution.

14. A system as in claim 11, wherein said means for comparing is used to bind particular service providers to a selected service choreography for the solution.

15. A system as in claim 11, wherein said comparing is used to monitor performance of the business solution.

16. A system as in claim 11, wherein the aggregation reflects synergistic effects among solution elements, said effects being represented in one or more linear or non-linear mathematical formulae or rules.

17. A system as in claim 11, wherein the aggregation reflects cannibalizing effects among solution elements, said effects being represented in one or more linear or non-linear mathematical formulae or rules.

18. Implementing a service for business solution validation in a component business model, comprising the method of:
defining a business solution composed of a set of services exposed by components in a component business model of a business, said services being formed into a service composition structure;
evaluating each of said services according to metrics that are surrogates for metrics measuring objectives of said business solution;
aggregating said service evaluations in accordance with said service composition structure; and
comparing said aggregation against target values of said surrogate metrics measuring said business solution objectives to validate the business solution.

19. The method of implementing a service as in claim 18, wherein said surrogate metrics for evaluating services are defined in a Business Service Level Agreement (BSLA) for each service composing the business solution.

20. The method of implementing a service as in claim 19, wherein said surrogate metrics are found by statistical analysis using data in a CBM repository to compare metrics defined in a Business Level Agreement (BLA) with metrics defined in said BSLAs.
